(19) United States
(12) Patent Application Publication
(10) Pub. No.: US 2004/0245303 A1
(43) Pub. Date: Dec. 9, 2004

(54) Electronic toll pass device holder

(76) Inventor: Kurt Santayana, Luzerne, PA (US)

Correspondence Address: RATNERPRESTIA, P O BOX 980, VALLEY FORGE, PA, 19482-0980, US

(21) Appl. No.: 10/750,107

(22) Filed: Dec. 31, 2003

Related U.S. Application Data
(60) Provisional application No. 60/437,727, filed on Jan. 2, 2003.

(51) Int. Cl. B60R 7/00; B60R 9/00; B60R 11/00; A45F 4/00; A45C 15/00

(52) U.S. Cl. 224/585; 224/482

(57) ABSTRACT

A device holder for an electronic toll pass device for use in a vehicle. The device holder has a rear panel, a front panel, a base panel, and side plates. The base panel and side plates are connected to the front panel, base plate and rear panels and define an opening adapted to removably receive and retain an electronic toll pass device. Attached to the rear panel is a mounting apparatus for attaching the device holder to a vehicle. Attached to the front panel is a retaining device. The retaining device is adapted to store items including information cards, coin holders, eyeglasses, and papers.

### RELATED APPLICATION

This application claims the benefit of priority to U.S. Provisional Patent Application No. 60/437,727 filed on Jan. 2, 2003, the contents of which are incorporated in this application by reference.

### FIELD OF THE INVENTION

This invention relates to a holder for an electronic toll pass device. More specifically, this invention relates to a holder for an electronic toll pass device and retaining devices for items located in a vehicle.

### BACKGROUND OF THE INVENTION

In many parts of the country, bridges and highways require the payment of a toll. At certain toll plazas which experience heavy traffic volumes, the toll plaza becomes a source of traffic due to the limited number of lanes available to pay the toll. Conventional toll collection methods require the driver to deposit coins, tickets, and tokens at toll plazas. This takes time and adds to traffic congestion. One solution to reduce congestion at toll plazas is the electronic toll pass. Electronic toll pass devices are a toll collection technology that facilitates traveling, offers discounts to toll fares, and reduces traffic congestion. An example of an electronic toll pass device and system is the E-ZPass™ system and tags used in the Northeast United States, for example in Pennsylvania and New Jersey.

Electronic toll pass devices allow a driver to pay tolls electronically as the driver's vehicle passes through specially equipped toll lanes at the toll plaza. Electronic toll pass devices work by first having a driver register an account with an electronic toll pass company using a credit card, personal check, or cash. The driver then receives a small electronic toll pass device that attaches to the windshield inside the driver's vehicle. Within the electronic toll pass device is an electronic chip that contains information about the driver's vehicle and registered account and a battery to power the device. Each time a driver passes through a toll facility where an electronic toll pass device lane is offered, an antenna at the toll plaza reads the vehicle and account information contained in the electronic toll pass device. The appropriate toll is then electronically debited from the driver's account. With the electronic toll pass device, the driver does not have to stop at the toll plaza, but only slow the speed of the vehicle to the required speed (i.e. 5-10 mph). By eliminating the need to stop at the toll, the electronic toll pass devices alleviate traffic congestion at the tolls and are able to process more vehicles through the toll plazas.

In some states where electronic toll pass devices are used, the electronic toll pass devices are installed on the vehicle inside windshield with an adhesive fastener or hook and loop fastener. This is to help insure that the toll pass device is positioned to be properly read while traveling through a toll lane. One drawback of the adhesive fastener is that it does not permit the electronic toll pass device to be easily removed. This is inconvenient for business travelers who are using their personal vehicles, as well as others who may choose to remove the toll pass devices from time to time. For example, if a driver is using a personal vehicle for a business trip and needs a receipt for the toll to be reimbursed, the driver will not be able to obtain a receipt because the electronic toll pass device will debit the driver's personal account automatically. In other words, there is no way to turn on or off the electronic toll pass device. One solution to this inconvenience is for the driver to only pass through lanes of the toll plaza that do not offer the convenience of electronic toll pass devices. Because of the popularity of electronic toll pass devices, however, not every toll plaza has non-electronic device lanes. A better solution would be to remove the electronic toll pass device from the vehicle.

The hook and loop fastener used with some toll pass devices allows the driver to remove the electronic toll pass device from the vehicle windshield, however, problems still remain. One problem with the hook and loop fastener is that it requires a correspondingly aligned and mating hook or loop fastener on the vehicle to which it is being fastened. In addition, the hook or loop portion remains affixed to the windshield of the vehicle even when not being used to secure an electronic toll pass device.

In addition to a removable device holder for an electronic toll pass device, there is also a need for a device holder having easily accessible storage of items including informational cards, coin holders, eyeglasses, and papers.

### SUMMARY OF THE INVENTION

The present invention includes a device holder for an electronic toll pass device in a vehicle. The device holder has a rear panel, a front panel, a base panel, and side plates. Attached to the rear panel is a mounting apparatus for attaching the device holder to a vehicle. Attached to the front panel is a retaining device. The base panel and side plates are connected to the front panel, base plate and rear panels and define an opening adapted to removably receive and retain an electronic toll pass device.

### BRIEF DESCRIPTION OF THE DRAWINGS

Exemplary embodiments of the invention will be described with reference to the drawings, of which:

FIG. 1A is a perspective view of the rear panel of an exemplary embodiment of a device holder in accordance with the present invention;

FIG. 1B is the embodiment of the device holder shown in FIG. 1A containing an electronic toll pass device and a suction cup as the mounting apparatus in accordance with the present invention;

FIG. 2A is a perspective view of the front panel of an exemplary embodiment of a device holder;

FIG. 2B is the embodiment of the device holder shown in FIG. 2A containing an electronic toll pass device and a card holder as the retaining device;

FIG. 3 is an exploded view of a device holder system in accordance with the present invention;

FIG. 4A is a perspective view of the front panel of an exemplary embodiment of the device holder showing a coin holder as the retaining device in accordance with the present invention;

FIG. 4B is a perspective view of the front panel of an exemplary embodiment of a device holder showing a picture holder as the retaining device in accordance with the present invention;

FIG. 4C device is a perspective view of the front panel of an exemplary embodiment of a device holder showing an eyeglass holder as the retaining device in accordance with the present invention;

FIG. 4D device is a perspective view of the front panel of an exemplary embodiment of a device holder showing a paper clip as the retaining device in accordance with the present invention;

FIG. 4E is a perspective view of the front panel of an exemplary embodiment of a device holder showing a grasshopper clip as the retaining device in accordance with the present invention;

FIG. 5A is a perspective view of the rear panel of an exemplary embodiment of a device holder maintaining an electronic toll pass device in accordance with the present invention; and

FIG. 5B is a perspective view of the rear panel of an exemplary embodiment of a device holder showing the inside of the front panel having a protruding structure in accordance with the present invention.

### DETAILED DESCRIPTION OF THE INVENTION

Preferred features of embodiments of this invention will now be described with reference to the FIGS. It will be appreciated that the spirit and scope of the invention is not limited to the embodiments selected for illustration. Also, it should be noted that the drawings are not rendered to any particular scale or proportion. It is contemplated that any of the configurations and materials described hereafter can be modified within the scope of this invention.

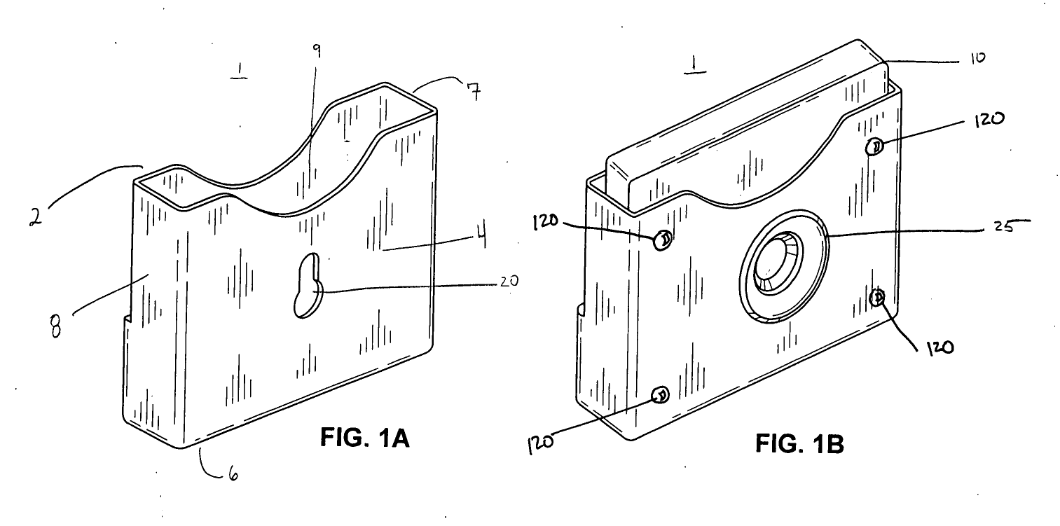

There is shown in FIGS. 1A-1B, a perspective view of the rear panel of an exemplary embodiment of device holder 1 in accordance with the present invention. Device holder 1 has front panel 2, rear panel 4, base panel 6, and side plates 7 and 8. Device holder 1 is constructed in such a manner so as to define opening 9 and is adapted to removably receive and retain electronic toll pass device 10. Attached to rear panel 4, is mounting apparatus 20. In this exemplary embodiment, mounting apparatus 20 is a keyhole designed to accept a “bayonet end” or mushroom style interface adaptor of suction cup 25 for removably affixing device holder 1 to a vehicle windshield. Suitable and contemplated equivalents of mounting apparatus 20 include, but are not limited to, a clip attached to the front panel to secure the device holder to a vehicle visor, a self-adhesive hook and loop fastener, if necessary, to attach the device holder to existing mounting apparatuses, a mounting arm to attach the device holder to the vehicle rear view mirror, and a vehicle dash-mounted frictional pad such as a bean bag pad or a tactile material such a NEOPRENE™.

In an alternative embodiment, at least one protruding structure 120, as optionally shown in FIG. 1B, may be mounted to rear panel 4. Protruding structure 120 mounted to the exterior of rear panel 4 serve to dampen vibrations that occur when the vehicle is in motion. Dampening the vibrations of device holder 1 against the windshield of the vehicle reduces the chances of the device holder 1 rattling against the vehicle windshield. Protruding structure 120 may be constructed of any suitable dampening material. Such material includes plastic or rubber, preferably rubber. The use of protruding structure 120 may be used for example when device holder 1 has suction cup 25 as a mounting apparatus 20.

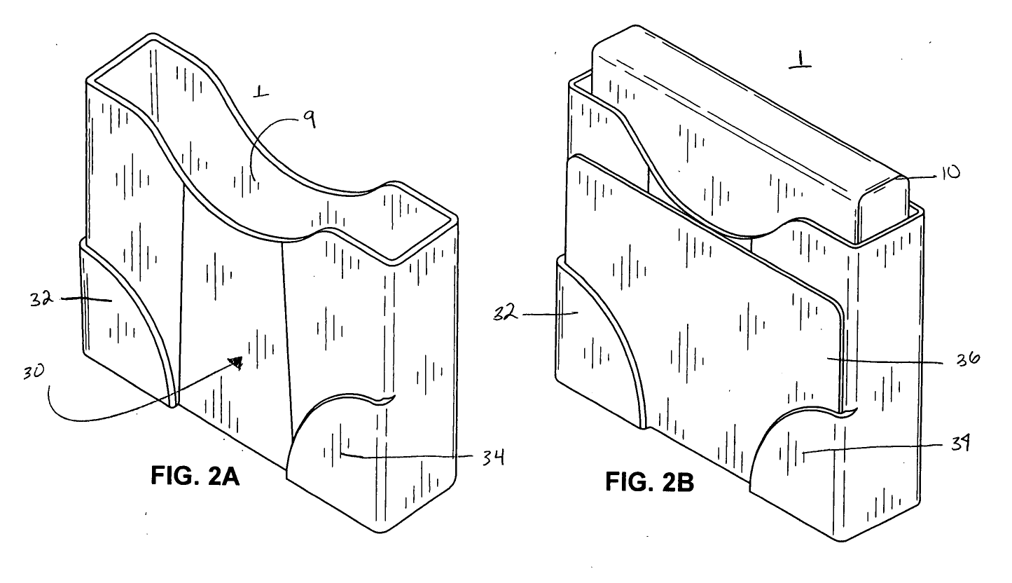

Shown in FIGS. 2A and 2B is a perspective view of an exemplary embodiment of device holder 1 having a retaining device attached to front panel 2. In the exemplary embodiment shown, the retaining device is card holder 30 having two tabs 32 and 34 for removably receiving and retaining business, credit or other informational cards 36.

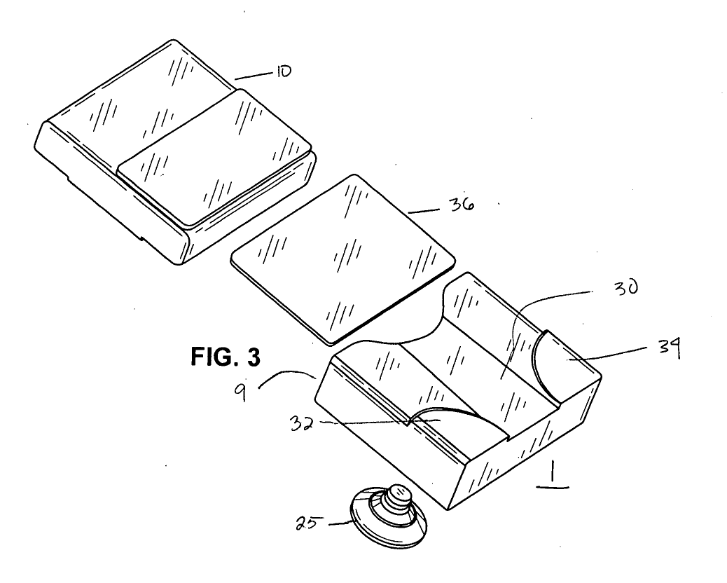

Shown in FIG. 3 is an exploded view of a device holder system that includes electronic toll pass device 10 to be inserted into opening 9, informational card 36 to be inserted into the retaining device, which is card holder 30, and suction cup 25 to be inserted into mounting apparatus 20 (not shown).

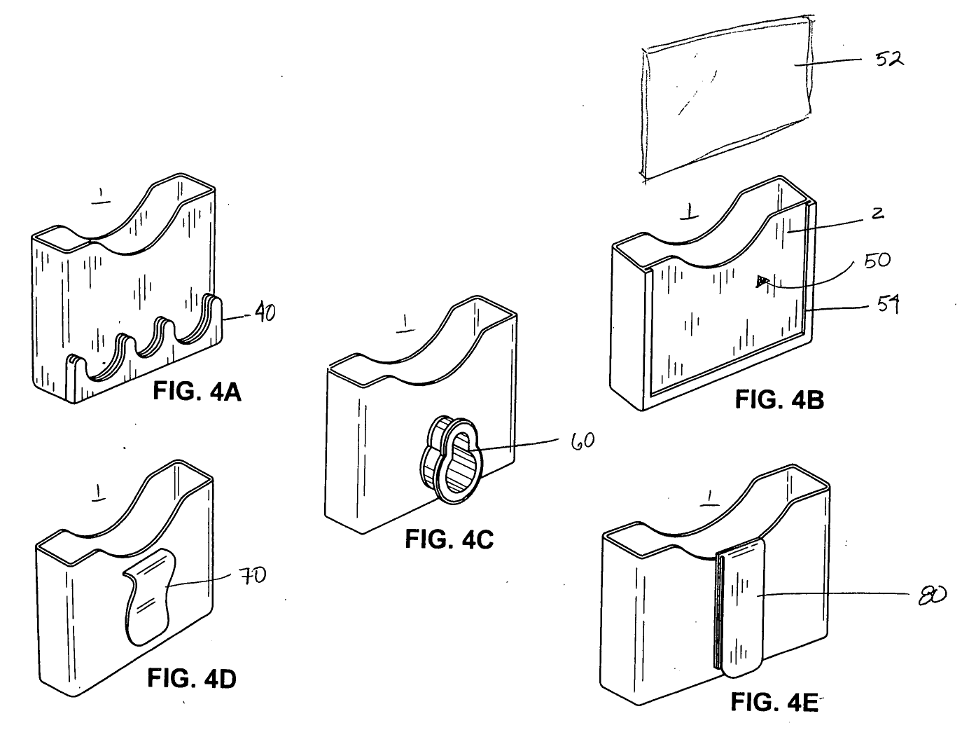

Shown in FIGS. 4A-4E are various exemplary embodiments of the retaining device attached to front panel 2. FIG. 4A shows an exemplary embodiment of the retaining device where the retaining device is coin holder 40. FIG. 4B shows an additional exemplary embodiment of the retaining device where the retaining device is picture holder 50. Picture holder 50 has grooves 54 in front panel 2. Picture frame window 52 engages grooves 54 to allow a picture to be placed between front panel 2 and picture frame window 52. Picture frame window 52 is constructed with plastic or any suitable transparent material, including materials to protect a picture from UV degradation. One such suitable material is acrylic. FIG. 4C is another embodiment where the retaining device is eyeglass holder 60. Eyeglass holder 60 may include a locking clasp to secure eyeglasses into place and a release button to allow the release of the eyeglasses from the locked clasp. FIG. 4D is yet another exemplary embodiment of the retaining device where the retaining device is clip 70. According to the embodiment shown in FIG. 4E, one end of clip 70 is rigidly fixed to front panel 2. The fixed end of clip 70 maintains the other, non-fixed end of clip 70 under tension. The non-fixed is end has a flared edged to allow papers to be more easily slid under clip 70. FIG. 4E is yet a further exemplary embodiment of the retaining device where the retaining device is grasshopper clip 80. Grasshopper clip 80 may be a conventional grasshopper clip and attached to front panel 2 via a hinge.

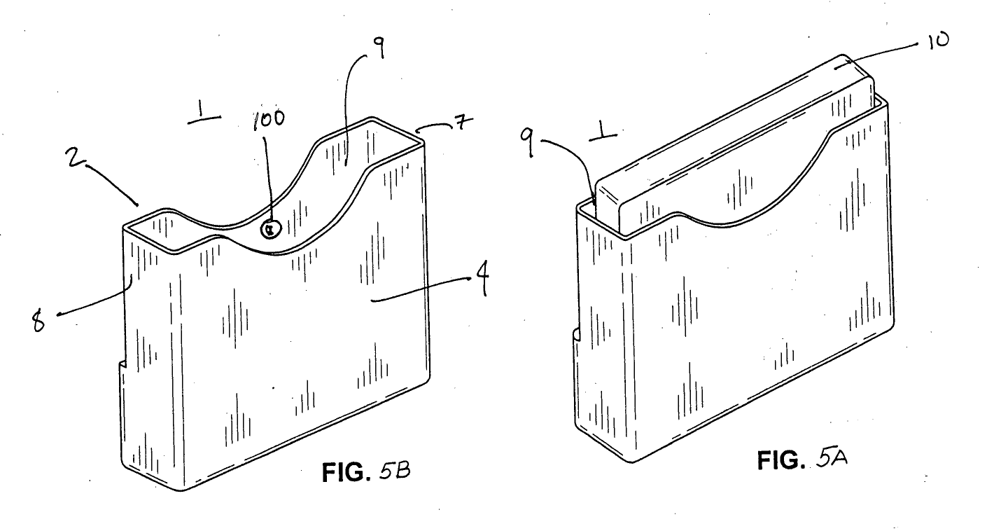

There is shown is FIG. 5A an exemplary embodiment of device holder 1 containing electronic toll pass device 10 in opening 9. When mounted to a vehicle windshield, electronic toll pass device 10 is maintained in opening 9 of device holder 1 by gravity. Device holder 1 may also be maintained in opening 9 of device holder 1 by a frictional fit. According to an another exemplary embodiment shown in FIG. 5B, protruding structure 100 is attached to the inside of front panel 2 to maintain electronic tall pass device 10 within device holder 1. As shown in FIG. 5B, protruding structure 100 is a semispherical knob attached to the inside of front panel 2. Alternative embodiments (not shown) of protruding structure 100 are a ball, ridge, lip or any other suitable protruding structure to insure a secure fit. Protruding structure 100 may be of unitary construction integrated with the panel or plate to which it is attached. Alternatively, protruding structure 100 may be a separate and distinct structure and/or material. In yet another embodiment, protruding structure 100 is attached to at least one of front panel 2, side panels 7 and 8, or rear panel 4. Protruding structure 100 may be constructed from the same material as the device holder or may be constructed of a different material, such as rubber. One of ordinary skill in the art would understand the suitable equivalents maintaining the electronic toll pass device within the device holder without departing from the spirit of scope of the invention.

Device holder 1, as described above, may be constructed of any suitable material including materials substantially resistant to UV degradation. The material, however, must also allow electronic toll pass device 10 to function properly and permit the transmission of signals to the antenna of the toll plaza. One such suitable material is ABS plastic. Device holder 1, as described herein has front panel 2, rear panel 4, base panel 6 and side plates 7 and 8. Device holder 1 is not limited to separate components, for example device holder 1 may be constructed as a unitary design. Front panel 2, rear panel 4, base panel 6, and side plates 7 and 8 of device holder 1 may be constructed by injection molding or cast from a common mold. One of ordinary skill in the art would understand the suitable equivalents of construction design without departing from the spirit of scope of the invention.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A device holder for an electronic toll pass device in a vehicle comprising:
a rear panel;
a mounting apparatus affixed to the rear panel for attaching the device holder to the vehicle;
a front panel;
a retaining device attached to the front panel;
a base panel; and
side plates connected to the front panel, base plate and rear panel defining an opening adapted to removably receive and retain the electronic toll pass device.

2. The device holder of claim 1, wherein the mounting apparatus is at least one suction cup.

3. The device holder of claim 2, wherein the rear panel further comprises at least one aperture for attaching the mounting apparatus to the device holder.

4. The device holder of claim 1, wherein the retaining device is a business or credit card holder.

5. The device holder of claim 4, wherein the card holder comprises at least two tabs for removably receiving and retaining business or credit cards.

6. The device holder of claim 5, wherein the at least two tabs are mounted to corners of the front panel.

7. The device holder of claim 1, wherein the retaining device of the front panel is an eyeglass holder.

8. The device holder of claim 7, wherein the eyeglass holder is a grasshopper clip attached to the front panel.

9. The device holder of claim 8, wherein the grasshopper clip comprises a locking clasp to secure eyeglasses into place and a release button to allow the release of the eyeglasses from the locking clasp.

10. The device holder of claim 1, wherein the retaining device is a paper holder.

11. The device holder of claim 1, wherein the retaining device is a picture holder.

12. The device holder of claim 11, wherein the picture holder further comprises a picture frame window secured to the front panel with sufficient space for a photograph to be inserted and stored between the picture frame window and the front panel.

13. The device holder of claim 12, wherein the front panel defines at least one groove adapted to removably receive and retain the picture frame window.

14. The device holder of claim 12, wherein the picture frame window is constructed of a plastic material.

15. The device holder of claim 1, wherein the retaining device is a change holder adapted to removably receive and retain at least one coin.

16. The device holder of claim 1, wherein at least the front, rear, side, and base panels are constructed of a material substantially resistant to UV degradation.

17. The device holder of claim 16, wherein the material is plastic.

18. The device holder of claim 1, wherein at least the front, rear, side and base panels are of a unitary design, constructed by injection molding, or are cast from a common mold.

19. The device holder of claim 1, wherein the opening is sized to retain the electronic toll pass device by frictional fit.

20. The device holder of claim 19, further comprising a protruding structure disposed on at least one of the front, side and rear panels.

21. A device holder for an electronic toll pass device in a vehicle comprising:
a rear panel;
a mounting apparatus comprising at least one suction cup affixed to the rear panel for attaching the device holder to the vehicle;
a front panel;
a retaining device attached to the front panel, the retaining device selected from the group consisting of a coin holder, picture holder, grasshopper clip, and eyeglass holder;
a base panel; and
side plates connected to the front panel, base plate and rear panel defining an opening adapted to removably receive and retain the electronic toll pass device.
